(19) United States
(12) Patent Application Publication
(10) Pub. No.: US 2008/0288470 A1
(43) Pub. Date: Nov. 20, 2008

(54) Method and System for Distributed Dns Resolution

(75) Inventors: Cedric Goutard, Douvres La Delivrande (FR); Karel Mittig, Caen (FR)

Correspondence Address: YOUNG & THOMPSON, 209 Madison Street, Suite 500, ALEXANDRIA, VA, 22314, US

(73) Assignee: FRANCE TELECOM, Paris (FR)

(21) Appl. No.: 11/664,694

(22) PCT Filed: Aug. 25, 2005
(86) PCT No.: PCT/FR05/02144

§ 371 Date: Apr. 5, 2007

(30) Foreign Application Priority Data
Oct. 6, 2004 (FR) 0410544

(51) Int. Cl. G06F 7/06; G06F 17/30; G06F 15/16

(52) U.S. Cl. 707/4; 709/202; 707/E17.014

(57) ABSTRACT

The invention concerns distributed DNS resolution of a DNS request comprising an FQDN domain name between terminal (T) and relevant parent server (SPP). The method consists in transmitting (A) a DNS request (r_DNS) to an extended intermediate relay server (SRE), and, in the absence of stored previous DNS resolution solution, inserting (B) in the request a DNS resolution extension variable (VE) to generate an extended DNS request (er_DNS), transmitting (C) the extended request to the parent server. Upon verification of the variable, searching (D) for a distributed DNS resolution agent (A_R_D), transmitting (E) an extended DNS reply EA DNS, containing the agent (A_R_D) to the relay server, executing (F) the agent to generate a DNS reply (A_DNS@IP) comprising at least the (FQDN) IP address and transmitting (G) the reply A DNS(?IP) to the terminal. The invention is applicable to DNS resolution on IP local area network or on the Internet.

The invention relates to a method and a system of intelligent resolution delegation for a Domain Name System (DNS), or distributed DNS resolution.

A client station generally accesses a server on the Internet (web server, video server, messaging server or other) after a process called DNS resolution for resolving its name or mnemonic address, for example “www.wanadoo.fr.”, into an IP address (Internet address) which is formed in general on four bytes “193.152.122.103” identifying the machine incorporating this server on the Internet network, in order to provide the physical connection of the client station to this server.

This DNS resolution process is implemented using the eponymous protocol (DNS protocol) and calls on a recursivity mechanism of the DNS resolution process.

By principle, the requesting client station sends its DNS resolution query to the DNS server of its Internet access provider or of its company. If this server is incapable of returning an IP address corresponding to the server name to be resolved, it contacts at its turn a parent DNS server (according to simple and well known configuration rules) in order to ask the latter to perform a resolution and return the response.

The same mechanism then applies for this parent server, and, through recursivity, the query in the end leads to a relevant DNS server that is an authority for the initial DNS resolution, which relevant DNS server returns, in accordance with that formally defined in the RFC (Request For Comment) documents RFC 1034 and RFC 1035, one or more IP addresses corresponding to the server name to be resolved.

This response is furthermore accompanied by time to live information indicating to the various DNS servers that have participated in the resolution process to preserve the response in memory, on disk or RAM, for the purposes of a later, more rapid, resolution.

Lastly, at the present time, the DNS resolution process provides for, conventionally, returning to the requesting client station and to the intermediate DNS servers either one or more response IP addresses, or an error message.

To be able to carry out this DNS resolution process, the DNS servers having authority for a domain name, for which they perform the final resolution or translation into an IP address, are configured:
either using “single” inputs associating one IP address with a machine name, called FQDN (Fully Qualified Domain Name);
or using “multiple” inputs, associating several IP addresses with a machine name, the server, in this case, returning this list as response;
or using more or less complex resolution processes or algorithms, for returning one or more addresses depending on parameters that are more or less developed, such as: IP address of the client station (or subnetwork), geographic location of the client station, and server load, for example. These DNS systems are described as intelligent DNS systems, insofar as the latter are capable of returning a response as a function of complex parameters and conditions, rather than a single input in a lookup table.

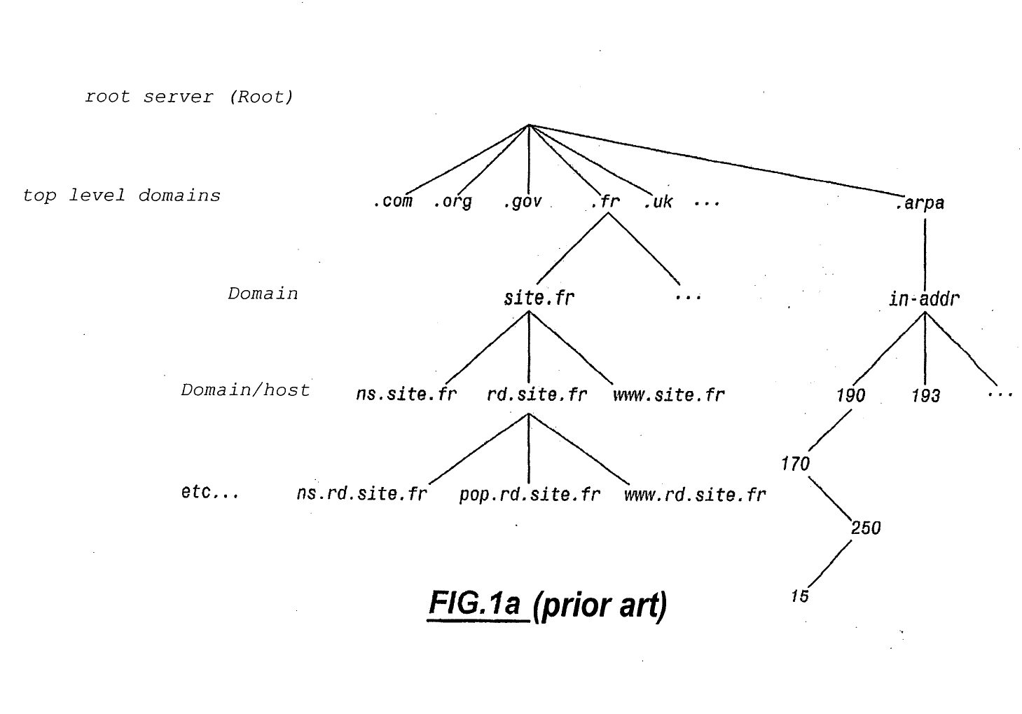

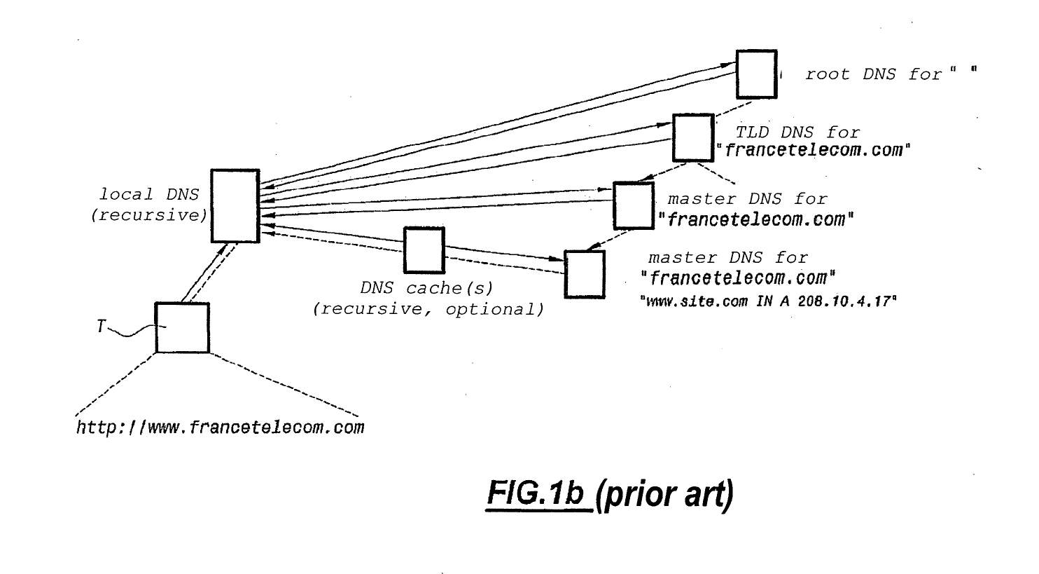

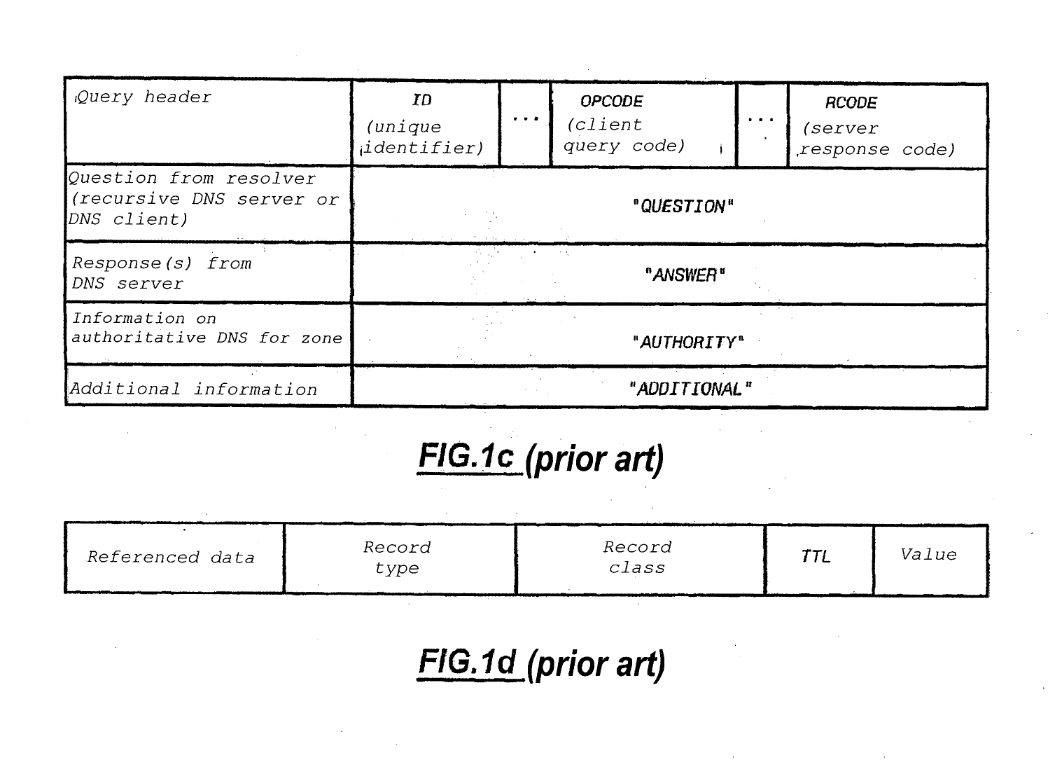

The operating method of the DNS model and protocol, as they are known in the prior art, will first be explained below with reference to FIGS. 1a to 1d.

The aim of the DNS model is to define a consistent name space for Internet resources, enabling a correspondence between a name and an IP address to be established at a given instant.

This model relies on a tree-structured system, capable of withstanding a high increase in load and allowing each organization to manage its addressing space.

In this tree-structured system, as represented by way of example in FIG. 1a, each node is a domain and each domain is also a subdomain, except for the root server.

The servers managing the abovementioned model are classed according to three functional roles:
servers responsible for managing the domains: these servers are referred to as iterative since they respond only to questions about the zones they manage;
intermediate servers; also called DNS caches, the purpose of these servers, which are optional, is to store the most frequently issued queries, in order to speed up DNS resolution times;
local servers: taking charge of queries by users, these servers are referred to as recursive since they can interrogate the whole DNS tree structure to resolve a query by a client.

The architecture of a such a functional subdivision is represented in FIG. 1b.

Since the DNS model is operated using the eponymous protocol, the DNS queries have the data structure represented in FIG. 1c.

In the Header field of the query, the OPCODE field is used by the client to indicate the nature of its request (name resolution, authentication), the RCODE field is used by the server to indicate whether the client request has been successful, and, if not, the reason for the failure.

The information contained in the “QUESTION”, “ANSWER”, “AUTHORITY” and “ADDITIONAL” fields corresponds to records, called RRs (Resource Records), being presented in a global form as represented in FIG. 1d.

The data in the “referenced data” field corresponds to the name requested by a client or to the name provided by a server. This data item is, most often, of the FQDN (Fully Qualified Domain Name) type, i.e. a mnemonic address, for example www.francetelecom.fr.

The “TTL parameter” data item indicates the time to live for the information. This data item or parameter is used in particular by cache DNS servers to store information temporarily.

The “record class” data item indicates the network in which to search for the resource.

Today, only the Internet network, data value IN, is used in practice.

The “value” data item corresponds to the response sent by the authoritative server back to the client. The syntax of the above-mentioned response varies according to the type of record.

Lastly, the “record type” data item is used to indicate the nature of record requested by the client or returned by the server.

There are currently 21 standard record types and about 20 experimental types. The most frequently used type is A for address, which indicates that a client is requesting an IP address in response to a server name.

Two other standard types, little used, can however be exploited:
the HINFO (Host Information) type enables a DNS server to supply information about its central processing unit CPU and its operating system, these information items each being presented in the form of an ASCII character string;
the TXT (Text) type, enabling a client or a DNS server to supply a free description, in the form of an ASCII character string.

Lastly, an extension mechanism for DNS queries, called EDNSO, is defined by the specification RFC 2671. This mechanism aims to remove some limitations of the DNS standard by the creation of new messages. The abovementioned extension mechanism is today mainly used to increase the maximum size of DNS queries and is substantially based on a modification of the OPCODE field and the use of a new type of resource called OPT.

As regards conventional DNS servers and their architecture, it is noted that these are based on the simple principle by which a lookup table is set up between, on the one hand, the managed resources, and, on the other hand, the associated responses. When a conventional DNS server receives a query from a client, it merely retrieves the response or responses associated with the question and sends the response(s) back to the client.

Among the DNS servers currently implemented, mention may be made by way of example of:

Bind: the server developed by the Internet Software Consortium, whose members have originated several DNS extension protocols;

Microsoft DNS server: this server was developed by the Microsoft Corporation, and became operational with the version supplied with the Windows 2000® operating system. This server, easily integrated in a Microsoft local network, is increasingly being used in the enterprise network context but remains less developed in the Internet context;

NSD (Name Server Daemon):

Having appeared recently in its first version in June 2003, this server is a DNS server, free of rights, developed by NLnet Labs. NSD is a purely iterative server having the particular feature of compiling its zone files as automata. This compilation process enables it to respond immediately to a query, since all the possible questions have been computed and pre-established beforehand and all the responses have been prerecorded.

Although it has appeared recently, NSD is today becoming more and more widespread and is used, in particular, as an authoritative DNS for managing top level domains, i.e. root domains the extensions of which relate to important areas, countries or groups, such as “.fr”, “.nl” or other.

The absence of a recursive operating mode means that this DNS server cannot be used to resolve client queries;

Power DNS: Developed by the company Power DNS BV, this server differentiates itself from previous solutions in that it relies on databases to manage the DNS records. The features associated with this implementation make Power DNS interesting for managing dynamic domains. However, it turns out to be ill-suited for use as a recursive DNS server.

As a result of the recent appearance of distributed hosting solutions for servers, the standard DNS resolution system has become insufficient.

Specifically, the latter does not provide for selecting, from a set of responses, the response that would be the most suitable for a given client.

Based on this observation, resolution solutions referred to as intelligent solutions have been proposed.

The abovementioned intelligent solutions, based on the DNS protocol, provide for measuring, using probes, various physical or operational parameters of the network providing the connection between a client and distributed server sites, such as network latency, and load on proxy server sites. Using these parameters, the abovementioned solutions assess, on comparison criteria, from a group of responses, the response which appears to be most suitable for a given client and only send that response to the client.

Intelligent DNS resolution solutions are marketed today in two forms:
CDNs (Content Delivery Networks), the main players for these types of services being the companies Akamai and Mirror Imager, for example;
DNS servers, the main players being the companies F5 3-DNS server and Cisco, for example.

The abovementioned prior art techniques exhibit the following drawbacks.

Conventional servers, capable only of finding one or more IP addresses to resolve an FQDN, mnemonic address, after consulting a lookup table, have the advantage of being simple and efficient. However, they do not provide for implementing an optimized and reliable DNS resolution for finding an IP address associated with a server name enabling fast and guaranteed access for the end client.

“Intelligent” servers, capable of finding one or more IP addresses to resolve an FQDN according to algorithms that are more or less complex, have the advantage of being able to respond to a client in an optimized and reliable manner but introduce the considerable disadvantage of managing, based on a centralized structure, all client queries, and, therefore, of requiring computation power proportional to the transmission rate to be provided, to the complexity of the resolution algorithm implemented and to the resolution parameters involved, such as the client IP address and server loads, for example.

Furthermore, in the current DNS resolution scheme, only the authoritative DNS server for an FQDN actually resolves the domain name, since it is the only computational power resource actually used.

The intermediate DNS servers, also called proxies, caches or relays, only act as resolution accelerators through temporary storage mechanisms and executions of resolutions according to rules defined by the RFC 1034 and RFC 1035 specifications.

To date, no DNS resolution exists that is both intelligent and distributed.

An object of the present invention is to implement an intelligent distributed DNS resolution method, at any extended intermediate relay server, with the aim of implementing the distributed DNS resolution method, and no longer only a process for distributing IP addresses between a relevant parent server that is an authority for a given domain name and the conventional DNS relay servers usually used between the client terminal and the relevant parent server.

Another object of the present invention is, in addition to implementing the abovementioned method, to implement an extended intermediate relay server enabling, from a relevant parent server, the implementation of the distributed DNS resolution method that is a subject of the invention, both the abovementioned method and the abovementioned relevant parent server remaining totally compatible with the currently applicable standards and advantageously being able to complement the latter.

Another object of the present invention is, lastly, by virtue of the implementation of the method that is a subject of the invention and by virtue of a plurality of extended intermediate relay servers connected as an IP network, Internet network or enterprise network, to share the computational power needed for complex DNS resolutions over all or part of the tree-structure of DNS relays and servers deployed, in order to fluidize the data exchange traffic over the abovementioned tree-structure.

The distributed DNS resolution method, subject of the invention, for a DNS query containing a domain name, the DNS query being transmitted between a client terminal and a relevant parent server that is an authority for the DNS resolution of this DNS query, is notable in that it involves transmitting from this client terminal to an extended intermediate relay server this DNS query for the DNS resolution of this query via this relevant parent server.

At this extended intermediate relay server, in the absence of a previous DNS resolution solution compatible with the domain name and stored at this extended intermediate relay server, it additionally involves inserting in this DNS query a distribution extension variable for this DNS resolution in order to generate an extended DNS query and transmitting, from this extended intermediate relay server to this relevant parent server, the extended DNS query.

At the relevant parent server, on confirming that the distribution extension variable is at the true value, the method that is a subject of the invention involves searching for and/or setting up a distributed DNS resolution agent and generating and transmitting to this extended intermediate relay server an extended DNS response containing at least this distributed DNS resolution agent.

At this extended intermediate relay server, it involves, lastly, storing and executing this distributed DNS resolution agent in order to generate a DNS response containing at least the IP address associated with this domain name and transmitting this DNS response to the client terminal.

This enables the execution of this DNS resolution to be distributed at this extended intermediate relay server.

The extended intermediate relay server enabling the implementation of the distributed DNS resolution method for a DNS query containing a domain name, and that is a subject of the present invention, this DNS query being transmitted between a client terminal and a relevant parent server, is notable in that it includes at least a module for checking for the presence of a previous DNS resolution solution compatible with this domain name and stored at this extended intermediate relay server, a module for storing and inserting, in this DNS query, a distribution extension variable for this DNS resolution for generating an extended DNS query, a module for transmitting this extended DNS query to this relevant parent server, a module for storing and executing a distributed DNS resolution agent transmitted by this relevant parent server to this extended intermediate relay server, this execution resulting in generating a DNS response containing at least the IP address associated with this domain name, and a module for transmitting this DNS response to this client terminal.

The method and the extended intermediate relay server, subjects of the present invention, are applied to the configuration of the architecture of the tree-structure of DNS relays and servers deployed in the context of enterprise networks or of the Internet network.

They will be better understood on reading the description and examining the drawings that follow in which, in addition to FIGS. 1a to 1d relating to the prior art:

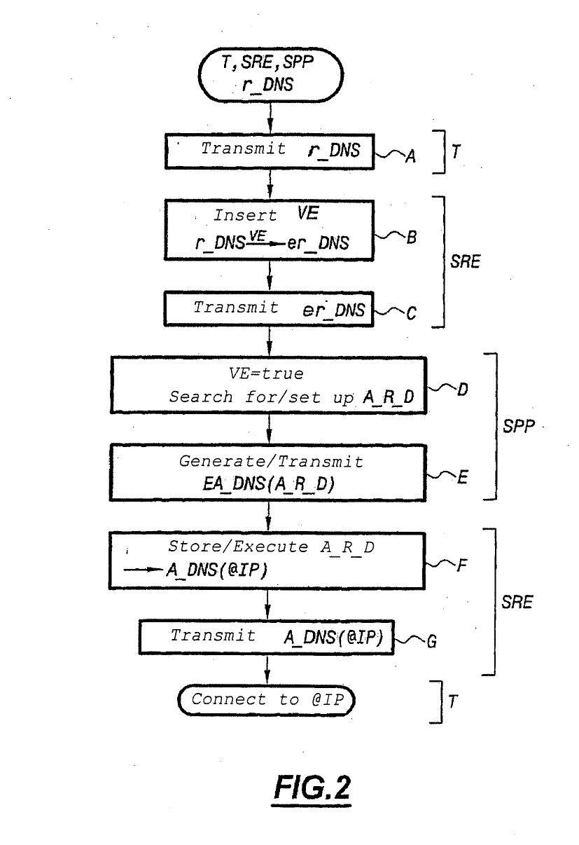

FIG. 2 represents, by way of illustration, a general flow chart of the steps essential to implementing the distributed DNS resolution method, subject of the present invention;

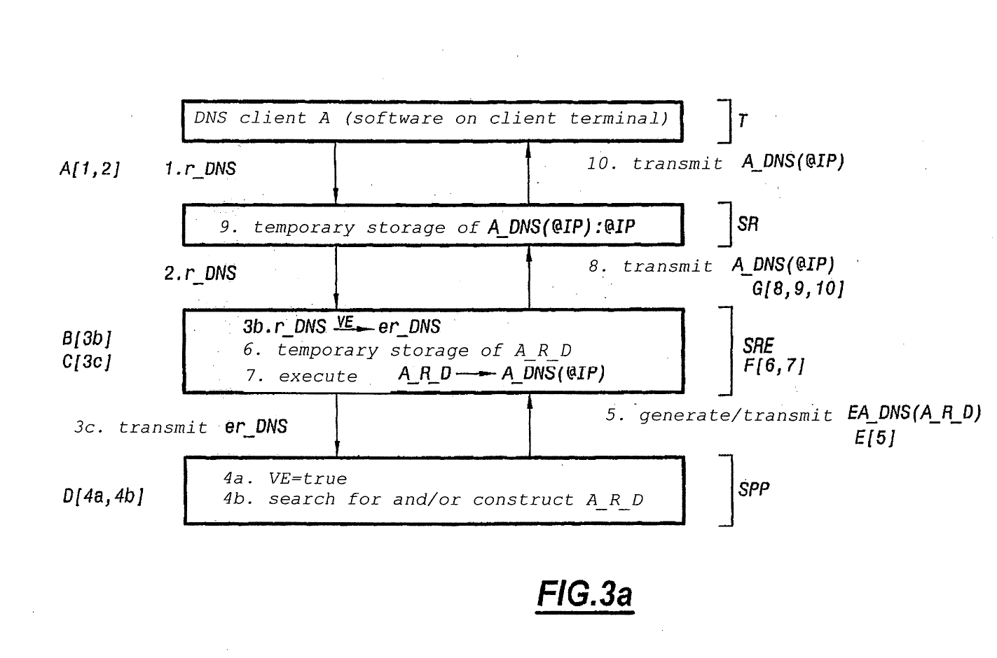

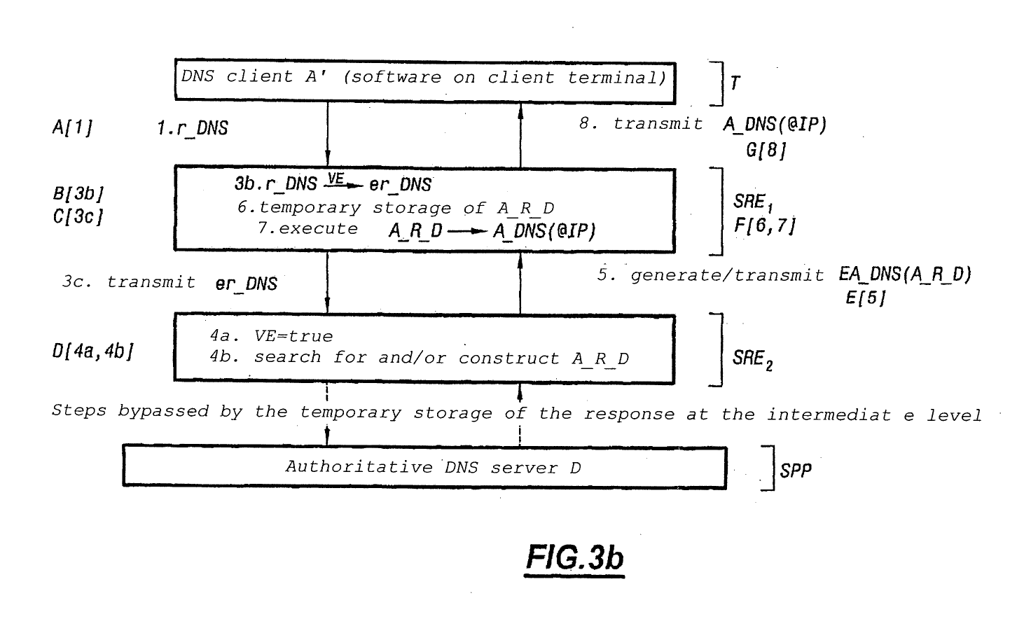

FIG. 3a represents, purely by way of illustration, a particular flow chart of the steps for implementing the distributed DNS resolution method, subject of the invention, in the case of a first scenario in which the DNS query is transmitted to the relevant parent server via a relay server or a conventional intermediate structure.

FIG. 3b represents, purely by way of illustration, a particular flow chart of the steps for implementing the distributed DNS resolution method, subject of the invention, in the case of a second scenario in which a previous DNS resolution solution, compatible with the DNS query and in particular the domain name contained in the latter, is stored in a second extended intermediate relay server of a level higher than a first extended intermediate relay server in the tree-structure of the relevant parent server in question;

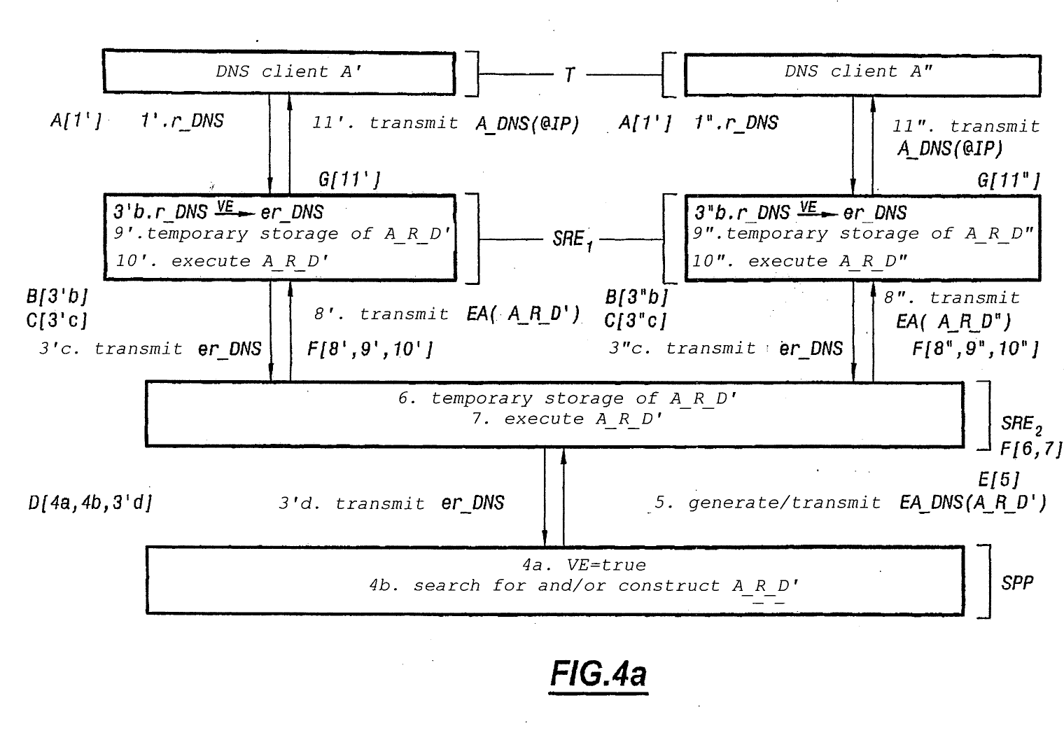

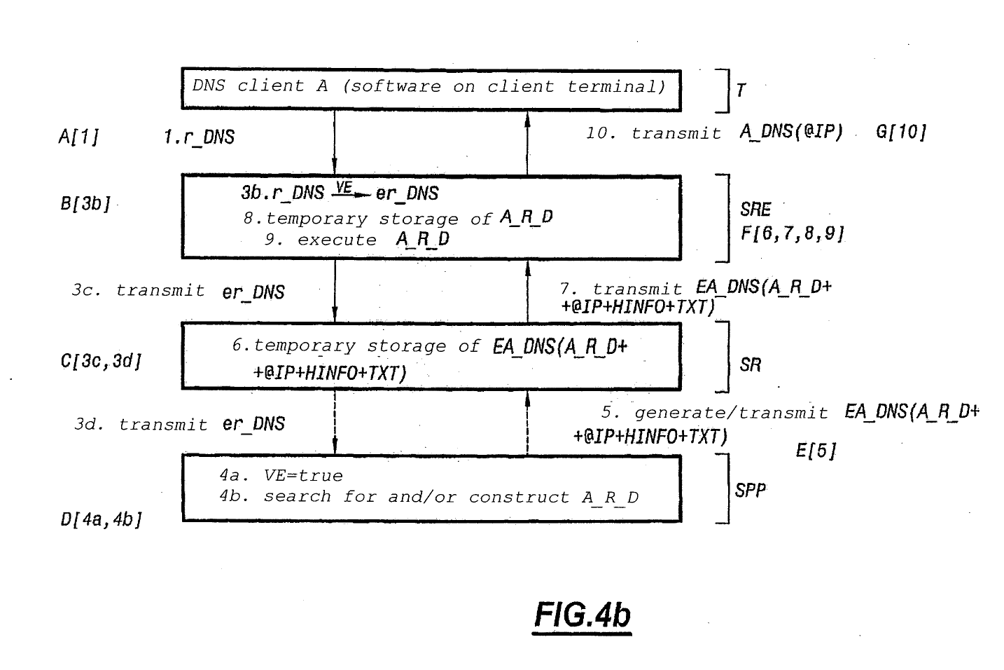

FIG. 4a represents, by way of illustration, a particular flow chart of the implementation of the distributed DNS resolution method, subject of the invention, when a first then a second client terminal transmit a DNS query relating to the same domain name or to different domain names able to call on however known distributed sites and the distributed DNS resolution method that is a subject of the invention being implemented, for the two scenarios, on a common extended intermediate relay server and distributed down to the lowest resolution level of extended intermediate relay servers relative to the relevant parent server;

FIG. 4b represents, purely by way of illustration, a particular flow chart of the implementation of the distributed DNS resolution method, subject of the present invention, based on a Bind DNS server specially adapted to implement the abovementioned method, it being used to ensure maximum compatibility with existing conventional DNS servers;

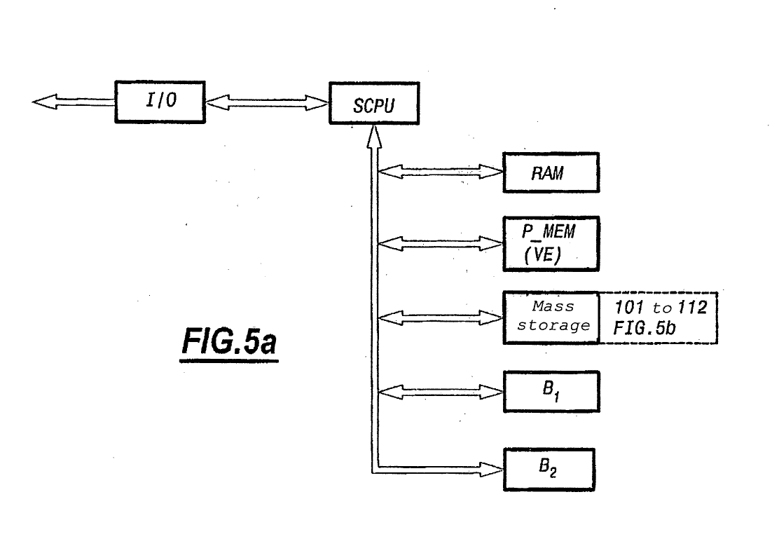

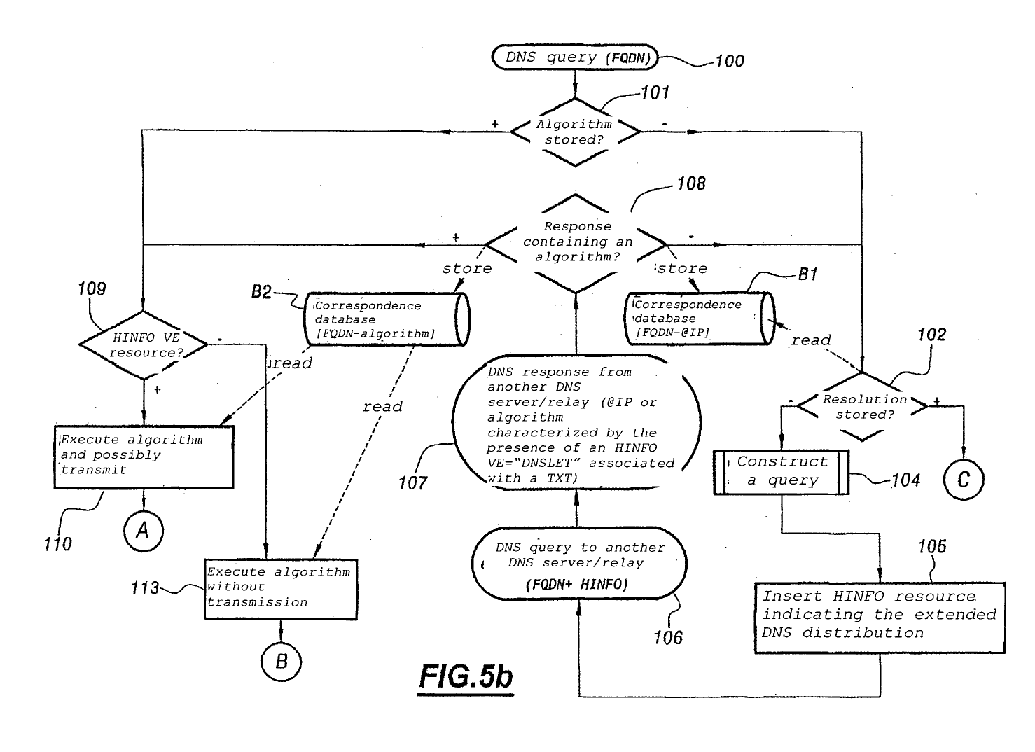

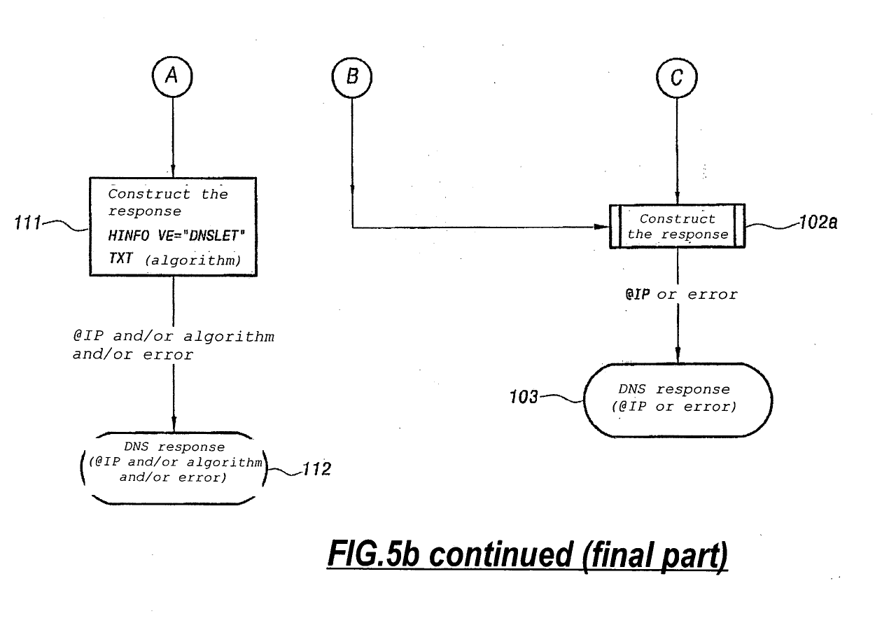

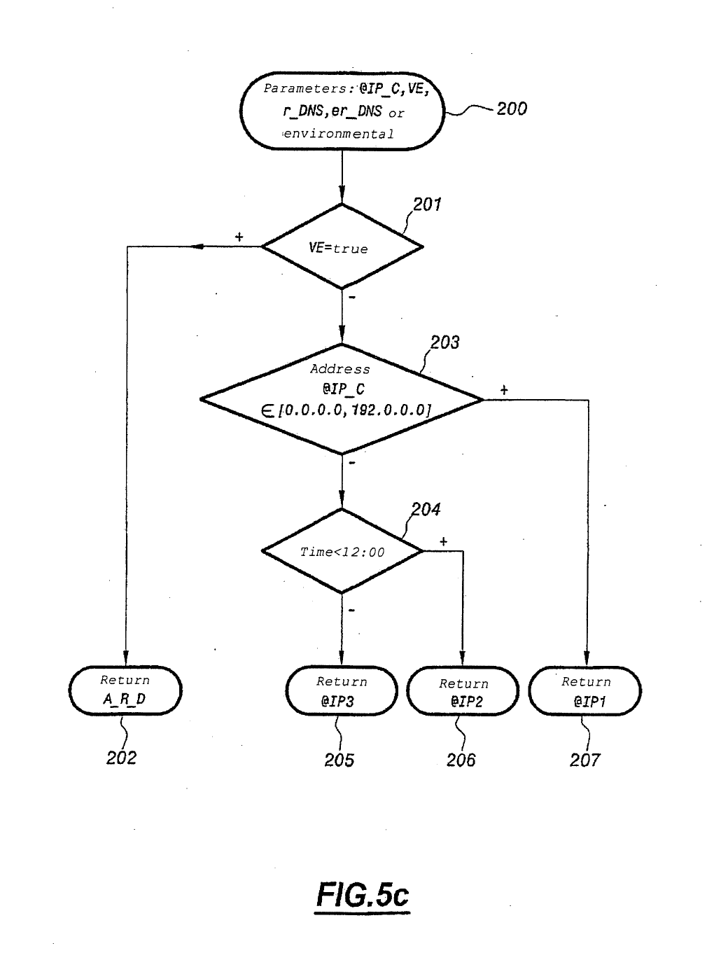

FIG. 5a represents by way of illustration a block diagram of an extended intermediate server, in accordance with the object of the present invention,

FIG. 5b represents, purely by way of illustration, an operational flow chart representing the operating mode of the extended intermediate server represented in FIG. 5a,

FIG. 5c represents, purely by way of illustration, a flow chart of the operational steps for distributing a distributed resolution agent A_R_D in accordance with the object of the present invention.

The distributed DNS resolution method in accordance with the object of the present invention will now be described in more detail with reference to FIG. 2 and the subsequent drawings.

Before the actual description of the abovementioned method, various indications will be given below relating to the notation used and the use of the corresponding reference symbols to denote the technical and/or functional items enabling implementation of the method that is a subject of the invention.

Generally, with reference to FIG. 2:
T denotes the client station or terminal originating a DNS query;
r_DNS denotes a DNS query of the conventional type transmitted by the client from the abovementioned terminal T;
SPP denotes a relevant parent server that is an authority for executing the DNS resolution and capable of implementing the method that is a subject of the present invention;
SRE denotes an extended intermediate relay server enabling the implementation of the method that is a subject of the present invention.

More specifically, it is noted that an extended intermediate relay server SRE is a server with two new features, namely a function to signal the use of distributed DNS resolution to any higher level intermediate relay server SRE, as well as to any relevant parent server SPP in order to execute the distributed DNS resolution, and a function to execute a distributed resolution agent A_R_D set up via the abovementioned relevant parent server SPP and under conditions fixed by the latter, as will be described later in the description.

With reference to FIG. 2, it is noted that the method that is a subject of the invention relates to a query r_DNS containing a domain name, i.e. a mnemonic name for a machine also called an FQDN, this query being transmitted between the abovementioned terminal T, client terminal, and of course a relevant parent server SPP that is an authority for the DNS resolution of the abovementioned query.

According to a notable aspect of the method of the invention, with reference to FIG. 2, the method involves at least, at a step A, transmitting from the client terminal T to an extended intermediate relay server SRE the query r_DNS for the DNS resolution of the latter via the relevant parent server SPP.

When at the extended intermediate relay server SRE there is no previous DNS resolution solution compatible with the domain name contained in the query, i.e. a previous solution stored at the extended intermediate relay server SRE, then the method that is a subject of the invention involves in a particularly advantageous manner, at a step B, inserting in the query r_DNS a distribution extension variable, denoted by VE, for this DNS resolution in order to generate an extended. DNS query, which is denoted by er_DNS.

In FIG. 2, at step B therein, the insertion operation is represented by the relationship:

r_DNS VE er_DNS

The operation B is then followed, at the extended intermediate relay server SRE, by a step C involving transmitting from the server SRE to the relevant parent server SPP the extended DNS query er_DNS.

After the query er_DNS is received at the relevant parent server SPP, the method that is a subject of the invention involves executing a step D for assessing, at the true value, the DNS resolution distribution extension variable VE. This operation is represented at abovementioned step D by the relationship: VE=true

The actual step D then includes an operation involving searching for and/or setting up a distributed DNS resolution agent, this agent being denoted by definition by A_R_D. This agent advantageously comprises a software agent, as will be described later in the description.

Step D is then followed by a step E executed at the server SPP and involving generating and transmitting from the relevant parent server SPP to the extended intermediate relay server SRE an extended DNS response denoted by EA_DNS (A_R_D) and containing at least the distributed DNS resolution agent, A_R_D.

After the extended DNS response EA_DNS (A_R_D) is received by the extended intermediate relay server SRE, the method that is a subject of the invention then involves, at a step F, storing and executing at the abovementioned extended intermediate relay server the resolution agent A_R_D in order to generate a DNS response containing at least the IP address, denoted by @ IP, associated with the domain name mentioned previously. In FIG. 2, at step F executed at the server SRE, the abovementioned DNS response is denoted by A_DNS (@IP).

The method that is a subject of the invention then involves, at a step G, transmitting the DNS response, response A_DNS (@IP), from the extended intermediate relay server SRE to the client terminal T.

With the abovementioned IP address @IP available, the terminal can then execute the connection requested by the client to the abovementioned address. Hence execution of the DNS resolution is distributed at the extended relay server SRE instead of a conventional execution at the relevant parent server SPP.

Generally, it is noted that the distributed DNS resolution method that is a subject of the invention is thus implemented by virtue of the definition of an extension of the conventional DNS protocol, this extension enabling DNS relays and servers to indicate support of the technology used, in accordance with the method that is a subject of the invention.

More specifically, it is noted that the abovementioned extension is realized via the distribution extension variable VE, this extension being able for example, in a nonlimiting manner, to reuse an existing type of resource, take the form of a new OPT type DNS resource in accordance with recommendation RFC 2671 or use a specific identifier in the OPCODE field of the query.

Furthermore, use of the abovementioned extension enables the relevant parent server SPP that is an authority for a given FQDN domain name to return a distributed resolution agent A_R_D, which can, by way of nonlimiting example, be realized in the form of a function written in the Perl language, to an extended intermediate relay server SRE which by definition provides for implementing the method that is a subject of the invention.

Each extended intermediate relay server SRE hence provides for implementing the distributed DNS resolution by executing the distributed resolution agent A_R_D at each DNS query and in particular with each FQDN domain name associated with the query, there is associated a distributed resolution agent A_R_D and not one or more IP addresses.

Furthermore, the main parent server SPP that is an authority for the FQDN domain name in question and implementing the method that is a subject of the invention executes a configuration method for defining which distributed resolution agent A_R_D must be returned upon a DNS query, r_DNS, from a client to an extended intermediate relay server SRE.

Various schemes implementing the method that is a subject of the present invention will now be described with reference to FIGS. 3a and 3b.

In the case of FIG. 3a, and by way of nonlimiting example, the diagram or functional scenario presents the principle of implementation of the method that is a subject of the invention when none of the extended intermediate relay servers SRE has previously performed a DNS resolution or when the time to live for the stored resolution solution or resolution agent A_R_D has expired.

FIG. 3a corresponds to a scenario in which the DNS query r_DNS or, if necessary, an extended DNS query er_DNS is transmitted via a conventional relay server denoted for this reason by SR, this type of server being a bin server, for example.

In this situation, it is understood that the method that is a subject of the invention involves storing and transmitting the DNS query or the extended DNS query to the relevant parent server SPP. Of course this provides total compatibility of the implementation of the method that is a subject of the present invention with existing networks, the abovementioned method that is a subject of the invention being capable of being implemented independently of the number of conventional relay servers SR participating in the transmission of any DNS query, respectively of any extended DNS query, to the main parent server SPP.

More specifically, in the context of FIGS. 3a and 3b, the implementation of the procedure that is a subject of the present invention is described in the form of transactions between the terminal T, via a conventional intermediate relay server SR or an extended intermediate relay server SRE, and the main parent server SPP and the equivalence between the steps represented in FIG. 2 and the abovementioned transactions is set out in table 1 below and transferred onto FIG. 3a.

The transactions are as follows:

1. transmission of the query r_DNS,

2. transmission of the query r_DNS between the server SR and the server SRE,

3b. insertion of the extension variable VE,

3c. transmission of the extended DNS query er_DNS,

4a. confirmation of the extension variable VE at the true value, VE=true,

4b. search for and/or construction of the distributed resolution agent A_R_D,

5. generation/transmission of the extended DNS response EA_DNS (A_R_D),

6. temporary storage of A_R_D,

7. execution of A_R_D to generate the DNS response A_DNS (@IP),

8. transmission of the response A_DNS (@IP),

9. temporary storage of A_DNS (@IP),

10. transmission of A_DNS (@IP).

| Step | Transaction |
|---|---|
| A | [1, 2] |
| B | [3b] |
| C | [3c] |
| D | [4a, 4b] |
| E | [5] |
| F | [6, 7] |
| G | [8, 9, 10] |
| — | — |

FIG. 3b takes up a similar example in the case of a different client A′ using a first extended intermediate relay SRE₁ and transmitting its DNS query after the client A in the case of FIG. 3a to the conventional intermediate relay server SR replaced by the extended intermediate server SRE₁ mentioned previously, the extended intermediate relay server SRE₂ of FIG. 3b then playing the specific role of extended intermediate relay server SRE of FIG. 3a but in a different situation in which there exists a priori a previous resolution solution upon transmission of the query by the client A′.

The transactions that take place in the case of FIG. 3b are partly the same as those that take place in the context of FIG. 3a but transactions 2, 9 and 10 are then suppressed while the transactions or steps between the extended intermediate relay server SRE₂ and the relevant parent server SPP are themselves short-circuited due to the temporary storage of the response at intermediate level, i.e. at the extended intermediate relay server SRE₂.

It is understood, in particular, that due to the abovementioned temporary storage, transactions 4a and 4b performed beforehand in the context of FIG. 3a at the relevant parent server SPP are now carried out at the extended intermediate relay server SRE₂, while transactions 3b, 6, 7 of insertion of the distribution extension variable VE, of temporary storage of the distributed resolution agent A_R_D and the execution of this agent are now carried out at the intermediate relay server SRE₁ which therefore actually acts as the extended intermediate relay server SRE of FIG. 3a. This storage step avoids a situation of queries/responses with the server SPP and also, on the one hand, substantially improves the response time for the client and, on the other hand, relieves the server SPP.

The equivalence between the steps of FIG. 2 and the various transactions is set out in table 2 below:

TABLE 2

| Step | Transaction |
|---|---|
| A | [1] |
| B | [3b] |
| C | [3c] |
| D | [4a, 4b] |
| E | [5] |
| F | [6, 7] |
| G | [8] |
| — | — |

Various technical results obtained and a detailed description of a specific implementation of the method that is a subject of the invention will now be given with reference to FIGS. 4a and 4b.

Generally, it is noted that the method that is a subject of the invention is used to propagate no longer only conventional DNS resolutions, i.e. one or more IP addresses, but instead, distributed resolution agents A_R_D.

In one preferred implementation, the abovementioned resolution agents are software agents written in a common programming language, grammar and rules, and in observance of documents RFC 1034 and RFC 1035 in the construction of DNS responses, in particular as regards the time to live for the resolutions.

By propagating distributed resolution agents the load of the intelligent central DNS servers can thus be reduced by shifting the computational load required for the resolution to lower level DNS relays and/or servers.

The use of distributed resolution agents A_R_D furthermore means that a high level of resolution intelligence can be offered enabling in particular to take into account the IP address of the client when the distributed resolution agent A_R_D can be propagated up to the top DNS resolution level, i.e. of the DNS relay of the Internet access provider for example, which no current DNS resolution solution is able to allow.

According to a particularly notable aspect of the method that is a subject of the present invention, as represented in FIG. 4a, a principle of recursivity can be employed in the propagated distributed resolution agents A_R_D, by allowing the latter to deliver in their turn not only one or more IP addresses but also all or part of themselves, as represented in the abovementioned FIG. 4a.

With reference to FIG. 4a, a situation is considered for two DNS clients A′, A″, each transmitting a query through transactions 1′ and 1″ respectively.

Each client A′ and A″ is assumed, for the purposes of the description and in a nonlimiting manner, to implement the method that is a subject of the invention, according to the scenario of FIG. 3b, i.e. from a first extended intermediate relay server SRE₁, that is distinct for each of the clients A′ and A″ and from a second extended intermediate relay server SRE₂, having substantially the same role as in the case of FIG. 3b.

Assuming that the client A′ transmits its query first, and receives of course a DNS response, A_DNS(@IP), according to the operating mode of FIG. 3b, transactions 4a and 4b are however shared between the second intermediate relay server SRE₂ and the main parent server SPP in the case of FIG. 4a, in the absence of a suppression or short-circuiting of the steps through a temporary storage of the response at the intermediate level SRE₂.

Under these conditions, it is understood that steps 1, 3b, 3c are replaced by transactions 1′, 3′b, 3′c, with an additional transaction 3′d taking place between the intermediate relay server SRE₂ and the main parent server SPP for the shared execution of transactions 4a and 4b.

The same is true for client A″ relative to transactions 1″, 3″b and 3″c.

Under these conditions, it is understood that the operation for sharing transactions 4a and 4b concerning the search for and/or reconstruction of the distributed resolution agent A_R_D′, then the temporary storage of this distributed resolution agent and execution of the latter at the second intermediate relay server SRE₂ enable on the one hand, the execution of a DNS resolution with multiple IP addresses, and, on the other hand, the subdividing of the distributed resolution agent ARD′ at the server SRE₂ into functional parts of the latter and in particular into a functional part A_R_D″. The latter can then be adapted according to the domain name features required by client A″ and the specific nature of the terminal of client A″, in order to then execute the abovementioned distributed resolution agent ARD″ at the intermediate relay server SRE₁ participating in the transaction requested by the client A″.

The equivalence between the steps of FIG. 2 and the transactions represented in FIG. 4a is set out in table 3 below.

TABLE 3

| Step | Transaction |
|---|---|
| A | [1′] [1″] |
| B | [3′b] [3″b] |
| C | [3′c] [3″c] |
| D | [4a, 4b, 3′d] |
| E | [5] |
| F | [6, 7] |
| | [8′, 9′, 10′] [8″, 9″, 10″] |
| G | [11′] [11″] |
| — | — |

The method that is a subject of the invention can preferably be implemented in a nonlimiting manner by means of a Bind DNS server.

Such a form of implementation will now be described with reference to FIG. 4b, through the use of the HINFO and TXT resource types of the bind protocol, these resource types having the effect of ensuring maximum compatibility with existing DNS servers.

An extended intermediate relay server SRE implemented using a bind DNS server provides for implementing the method that is a subject of the invention using the modifications or adaptations below:

1. Transmission of an HINFO record in the additional field of DNS queries. This type of record incorporates two parameters coded in character string form and is advantageously used to implement the method that is a subject of the invention. Thus, the character string CPU can be used according to the object of the present invention to indicate that the server SRE supports the use of the method that is a subject of the invention by taking for example as value for the variable VE=“DNSLET” while the character string OS can be used to indicate a possible version of the protocol associated with the invention, version “1.0” for example.

2. If a server SRE or the server SPP receives an extended DNS query containing therefore an HINFO record of value VE=“DNSLET”, the extended DNS responses are obtained by insertion in the additional field of an HINFO record, as mentioned above, associated with a record in the TXT field. This type of record in the TXT field is then used to transmit the distributed resolution agent A_R_D in character string form. It is of course understood that the later execution of this agent is understood as being from a compiled version of the agent, for example:
implementation of a DNS query processing function for detecting the presence of the variable VE in the HINFO record containing the value VE=“DNSLET” and thus differentiating extended DNS queries from conventional DNS queries and responding either by a conventional DNS response, or by an extended DNS response, i.e. containing a distributed resolution agent A_R_D.
a query processing function is implemented, which is used to invoke a program (for example a program written in Perl language in text, TXT, format) on reception of a DNS query when such a program has been associated with the FQDN domain name to be resolved.
implementation of a function processing responses from higher level DNS servers for storing a distributed resolution agent A_R_D associated with the FQDN domain name, in addition to conventional storage rules defined in the Bind server.
implementation of a configuration interface for specifying the distributed resolution agent to be applied or transferred on reception of a DNS query when the DNS server is an authority for the FQDN domain name.

Implementing the method that is a subject of the invention by using the HINFO and TXT records of the Bind protocol presents a particularly interesting advantage with regard to other possibilities implemented, since these two standardized fields are supported by all existing DNS servers. Furthermore, since these records are stored in the additional part of a DNS query and response, they provide for sending back, at the same time, a conventional response, i.e. an address @IP associated with a response linked to the use of the method that is a subject of the invention, i.e. to the transmission of a distributed resolution agent A_R_D.

It is understood that use of the abovementioned fields enables the implementation of the method that is a subject of the present invention, even when conventional type DNS servers, i.e. those which are not able to implement the method that is a subject of the present invention, are placed between one or more SRE servers. It is also understood, and described earlier in the description, that the conventional type intermediate relay servers actually analyze only the conventional response but preserve HINFO and TXT records in order to transmit these in one direction or in the other.

The implementation of the method that is a subject of the present invention, in the case of a modified bind DNS server system, i.e. an SRE server, is illustrated and described with reference to FIG. 4b.

This figure represents an intermediate scenario mentioned previously in the description in which the extended intermediate relay server SRE is interconnected with the main parent server SPP via a conventional type relay server SR.

Table 4 below sets out the equivalence between the steps of FIG. 2 and the transactions that take place in this scenario.

| Step | Transaction |
|---|---|
| A | [1′] |
| B | [3′b] |
| C | [3c, 3d] |
| D | [4a, 4b] |
| E | [5] |
| F | [6, 7, 8, 9] |
| G | [10] |
| — | — |

In particular, due to the flexibility in implementing the method that is a subject of the present invention, it is understood that with the prior presence of a DNS resolution compatible with the domain name and stored at the extended intermediate relay server, the latter can involve at least either transmitting a DNS response containing at least the IP address associated with the domain name contained in the extended DNS query when the previous DNS resolution solution is an explicit solution containing the IP address, or executing the distributed DNS resolution agent in order to generate a DNS response containing the IP address when the previous solution is an implicit solution comprising the existence of a DNS resolution agent compatible with the domain name in question. Transmitting an explicit solution can be justified in particular when the DNS resolution has been distributed down to the lowest level, i.e. to the relay server of the access provider for example. In this situation, it is of course advantageous to preserve the explicit DNS resolution solutions in order to avoid an unnecessary use of computation time.

Lastly, according to a particularly advantageous aspect of the method that is a subject of the present invention, it is noted that the step involving transmitting at least the distributed DNS resolution agent from the relevant parent server to the extended intermediate relay server SRE also involves transmitting a variable representing the time to live for this distributed DNS resolution agent, in order to ensure sound management of computational resources and memory space of any extended intermediate relay server SRE implemented according to the object of the present invention. The relevant parent server SPP can be formed of a conventional server, known to a person skilled in the art, and for this reason, it will not be described in detail.

A more detailed description of an extended intermediate relay server SRE for implementing the method that is a subject of the present invention will now be given with reference to FIG. 5a and FIG. 5b.

As mentioned previously, an SRE server in accordance with the object of the present invention can be implemented using a Bind relay server. Therefore, the SRE server comprises, as represented in FIG. 5a, all the conventional components of a server of the abovementioned type and in particular a server central processing unit SCPU connected to an input/output unit I/O providing of course the interconnection of the server with any external machine, random access memory RAM and of course a mass storage unit, permanent memory unit such as hard disk or other.

These items will not be described in detail since they are prior art items the operations of which are very well known.

Furthermore, and according to a notable aspect of the extended intermediate relay server SRE that is a subject of the present invention, the latter advantageously includes a non-volatile programmable memory, which is read/write protected, referred to as P_MEM, as well as a database of correspondence between a plurality of domain names and at least one distributed DNS resolution agent, this correspondence database denoted by B2, and a database B1 of correspondence between a plurality of domain names and at least one IP address. The abovementioned databases B1 and B2 can be combined into a single database.

In general, it is noted that the hard disk type permanent memory contains software modules, which are for implementing all the features of the SRE server as regards the process of insertion of the variable VE, i.e. of the HINFO resource indicating the extended DNS distribution and more particularly the declaration of availability of use of the distributed DNS resolution method at the abovementioned extended intermediate relay server SRE when the variable VE is at the true value. The abovementioned software modules are also used to implement the process for constructing an extended query er_DNS or an extended response EA_DNS under the conditions explained earlier in the description.

In FIG. 5a, the corresponding software modules are referred to as “101 to 112 FIG. 5b”, the references 101 to 112 referring to the functional references represented in FIG. 5b.

Thus, the extended intermediate relay server SRE that is a subject of the invention can advantageously include a module for checking for the presence of a previous DNS resolution solution compatible with the domain name and stored at the extended intermediate relay server, a module for storing and inserting in the DNS query the distribution extension variable VE of the DNS resolution for generating an extended DNS query, query er_DNS, a module for transmitting the extended DNS query to the relevant parent server, a module for storing and for executing a distributed DNS resolution agent transmitted by the relevant parent server SPP to the extended intermediate relay server module SRE as represented in FIGS. 5a and 5b. This provides for generating the DNS response containing at least the IP address associated with the abovementioned FQDN domain name. Lastly, a module for transmitting the DNS response to the client terminal T is also provided.

As regards the modules for transmitting the extended DNS query to the relevant parent server SPP and the module for transmitting the DNS response to the client terminal T, it is of course understood that the abovementioned modules are software modules, which via the central processing unit SCPU and the input/output unit I/O provide for transmitting the corresponding messages according to the format as described earlier in the description for example.

The modules for checking for the presence of a previous DNS resolution solution and modules for storing and for inserting in the DNS query a distribution extension variable VE are also specific software modules stored in the abovementioned permanent memory, and are executed by the central processing unit SCPU.

The same is true for the module for executing the distributed DNS resolution agent, agent A_R_D, through the computational resources of the server SRE, i.e. the working memory RAM and the central processing unit SCPU.

With reference to FIG. 5b, on receiving a DNS query containing an FQDN domain name, the various functional operations at the SRE server can be carried out:

In the context of checking for the presence of a previous DNS resolution solution compatible with the domain name, i.e. a solution stored at the extended intermediate relay server, a test for checking the algorithm is provided it is noted that the notion of algorithm covers simply the basic text version, i.e. the uncompiled version, of the distributed resolution agent A_R_D or of any information item for compiling the latter.

If the response to test 101 is negative, a test 102 is provided to check for the existence of a stored previous resolution.

If the response to test 102 is positive, when for example an explicit previous solution exists, i.e. an IP address @IP compatible with the previously mentioned FQDN domain name, a step 102a is invoked, involving constructing the response A_DNS for transmission to the terminal T. The response is transmitted at step 103 of FIG. 5b.

However, if the response to test 102 is negative, a step 104 is invoked, which involves constructing an extended query er_DNS, this step involving, for example, a step 105 for inserting the HINFO resource indicating the extended DNS distribution, i.e. inserting the variable VE.

The operating mode of the server SRE is then considered if a DNS query to another DNS server/relay is received at step 106 then from the reception of an extended response containing of course an algorithm, i.e. a distributed resolution agent A_R_D. Since this operation is carried out at step 107 in FIG. 5b, a test 108 is provided to check that the abovementioned extended response contains an algorithm.

If the response to test step 108 is negative, the operating mode process is sent back to the test of step 102. Of course, step 104 for constructing a query calls on the correspondence database B1 for providing a correspondence of the FQDN domain name and of at least one IP address compatible with the latter.

If the response to test 108 is positive, and if the response to abovementioned test 101 is positive, i.e. in the presence of at least one algorithm i.e. a distributed resolution agent A_R_D, a test 109 is invoked, involving checking for the presence of the extension variable VE.

If the response to test 109 is positive, a step 110 is invoked for executing the algorithm after compiling the latter, i.e. the distributed resolution agent A_R_D, this step 110 being followed by a step 111 for constructing the response A_DNS, i.e. for actually communicating the IP address @IP compatible with the FQDN domain name and which constitutes the DNS resolution sought.

It is understood, and mentioned earlier in the description, that at step 111, the construction of the response involves communicating either an algorithm, or an algorithm and an IP address @IP.

The DNS response, A_DNS, can then be transmitted at step 112 to the terminal T.

However, if the response to test 109 is negative, a step 113 is invoked, which can involve executing the distributed resolution agent A_R_D without transmission. This step 113 is then followed by invoking step 102a for constructing the response. The latter operating mode can correspond to that described earlier in the description with reference to FIG. 4a, in which the execution of the distributed resolution agent A_R_D′ provides for distributing parts of the algorithm or of the distributed resolution agent.

The process for distributing the distributed DNS resolution agent A_R_D can advantageously be formed by a program module which can be executed by a computer including for example, as represented in FIG. 5c, a step 200 for extracting from a DNS query or from an extended DNS query parameters or conditions related to the initiator of the query, the client user, or environmental ones such as time of transmission of the query, existence of the resolution distribution extension variable at the true value, and client IP address @IP_C for example.

By way of nonlimiting example, the executable program module for distributing the distributed resolution agent A_R_D, as represented in FIG. 5c, includes a test 201 of support of the use of the method that is a subject of the invention, able for example to relate to confirmation of the DNS resolution distribution extension variable VE at the true value. If the response to test 201 is positive, a step 202 is invoked involving returning the distributed resolution agent A_R_D to the extended intermediate relay server SRE, i.e. originator and user of the extended DNS query. However, if the response to test 201 is negative, a process of diversification of the DNS response based on environmental parameters can advantageously be implemented.

By way of nonlimiting example, a first test 203 can involve discriminating on the value of the client address associated with the FQDN domain name in a specific range of values, the values 0.0.0.0 and 192.0.0.0 for example. If the response to test 203 is positive, the domain name associated with the Internet address is a first diversified value @IP₁ for example.

If the response to test 203 is negative, a new test 204 is provided, for discriminating on the time of transmission of the DNS query with regard to at least one time threshold value, 12:00 in the example given. If the response to test 204 is positive, the domain name associated with the Internet address at step 206 is a second diversified value @IP₂ for example. However, if the response to test 204 is negative, the domain name associated with the Internet address at step 205 is a third diversified value @IP₃ for example. It is intended that the diversification of the domain name transmitted to the client user in the DNS response advantageously provides for taking into account the usual conditions of access by the client to different domain names according to the abovementioned environmental parameters.

1-11. (canceled)

12. A distributed DNS resolution method for a DNS query containing a domain name, the DNS query being transmitted between a client terminal and a relevant parent server that is an authority for the DNS resolution of this DNS query, comprising:
(a) transmitting from the client terminal to an extended intermediate relay server the DNS query for the DNS resolution of the DNS query via the relevant parent server; and, at the extended intermediate relay server, in the absence of a previous DNS resolution solution compatible with the domain name and stored at the extended intermediate relay server,
(b) inserting in the DNS query a distribution extension variable for this DNS resolution in order to generate an extended DNS query;
(c) transmitting from the extended intermediate relay server to the relevant parent server the extended DNS query; and,
at the relevant parent server on confirming that the distribution extension variable is at the true value,
(d) searching for and/or setting up a distributed DNS resolution agent;
(e) generating and transmitting from the relevant parent server to the extended intermediate relay server an extended DNS response containing at least the distributed DNS resolution agent;
(f) storing and executing at the extended intermediate relay server the distributed DNS resolution agent, in order to generate a DNS response containing at least the IP address associated with this domain name;
(g) transmitting the DNS response from the extended intermediate relay server to the client terminal, thereby enabling the execution of the DNS resolution to be distributed at the extended intermediate relay server.

13. A method according to claim 12, further comprising, on transmission of the DNS query, respectively of the extended DNS query, via a conventional relay server, storing and transmitting the DNS query, respectively the extended DNS query, to the relevant parent server.

14. A method according to claim 12, further comprising, in the presence of a previous DNS resolution solution compatible with the domain name and stored at the extended intermediate relay server:
either transmitting a DNS response containing at least the IP address associated with the domain name contained in the extended DNS query, when the previous DNS resolution solution is an explicit solution containing the IP address;
or executing the distributed DNS resolution agent, in order to generate a DNS response containing the IP address, when the previous solution is an implicit solution consisting of the existence of a DNS resolution agent compatible with the domain name.

15. A method according to claim 12, wherein the step involving transmitting at least the distributed DNS resolution agent from the relevant parent server to the extended intermediate relay server comprises furthermore the transmission of a variable representing the time to live for the distributed DNS resolution agent.

16. A method according to claim 14, wherein in the presence of a previous DNS resolution solution compatible with the domain name and stored at the extended intermediate relay server, the steps involving inserting (b), transmitting (c), searching for and/or setting up (d), and generating and transmitting (e) are suppressed.

17. A method according to claim 12, wherein for a conventional type DNS query containing two fields of the HINFO and TXT record type that are empty during transmission of the DNS query by the client terminal, step (b) for insertion in the DNS query to generate an extended DNS query involves inserting in one of the empty fields a specific character string for which confirmation at the true value denotes a query declaring availability of the use of the distributed DNS resolution method at the extended intermediate relay server.

18. A method according to claim 12, wherein for an extended DNS query for which one of the two fields of the HINFO and TXT record type contains a distribution extension variable for this DNS resolution, the extended DNS response transmitted from the relevant parent server to the extended intermediate server includes at least:
the IP address associated with the domain name;
the distributed DNS resolution agent, inserted in the other of the two fields.

19. distributed DNS resolution method for a DNS query containing a domain name, the DNS query being transmitted between a client terminal and a relevant parent server that is an authority for the DNS resolution of this DNS query, comprising:
(a) an extended intermediate relay server receiving, from the client terminal, a DNS query for the DNS resolution of the latter via the relevant parent server;
(b) in the absence of a previous DNS resolution solution compatible with the domain name and stored at the extended intermediate relay server, the extended intermediate relay server inserting in the DNS query a distribution extension variable for this DNS resolution in order to generate an extended DNS query;
(c) the extended intermediate relay server transmitting to the relevant parent server the extended DNS query;
(e) the extended intermediate relay server receiving, from the parent server, an extended DNS response containing at least a distributed DNS resolution agent having been searched for and/or set up by the relevant parent server on confirming that the distribution extension variable is at the true value;
(f) the extended intermediate relay server storing and executing the distributed DNS resolution agent in order to generate a DNS response containing at least the IP address associated with this domain name;
(g) the extended intermediate relay server transmitting to the client terminal the DNS response, thereby enabling the execution of the DNS resolution to be distributed at the extended intermediate relay server.

20. A method according to claim 19, comprising, in the presence of a previous DNS resolution solution compatible with the domain name and stored, the extended intermediate relay server:
either transmitting a DNS response containing at least the IP address associated with the domain name contained in the extended DNS query when the previous DNS resolution solution is an explicit solution containing the IP address;
or executing the distributed DNS resolution agent in order to generate a DNS response containing the IP address when the previous solution is an implicit solution comprising the existence of a DNS resolution agent compatible with the aforementioned domain name.

21. A method according to claim 19, comprising, during the step in which the extended intermediate relay server receives from the parent server an extended DNS response containing at least a distributed DNS resolution agent, the extended intermediate relay server also receiving from the parent server a variable representing the time to live for the distributed DNS resolution agent.

22. A method according to claim 21, comprising, in the presence of a previous DNS resolution solution compatible with the domain name and stored, the extended intermediate relay server not carrying out the steps involving inserting (b), transmitting (c), and receiving (e).

23. A method according to claim 19, wherein, for a conventional type DNS query containing two fields of the HINFO and TXT record type that are empty during transmission of the DNS query by the client terminal, step (b) for insertion in the DNS query to generate an extended DNS query involves inserting in one of the empty fields a specific character string for which confirmation at the true value denotes a query declaring availability of the use of the distributed DNS resolution method at the extended intermediate relay server.

24. A method according to claim 19, wherein, for an extended DNS query for which one of the two fields of the HINFO and TXT record type includes a distribution extension variable for this DNS resolution, the extended DNS response transmitted from the relevant parent server to the extended intermediate server includes at least:
the IP address associated with the domain name;
the distributed DNS resolution agent, inserted in the other of the two fields.

25. A distributed DNS resolution method for a DNS query containing a domain name, the DNS query being transmitted between a client terminal and a relevant parent server that is an authority for the DNS resolution of this DNS query, comprising:
(c) the relevant parent server receiving, from an extended intermediate relay server, an extended DNS query generated, at the extended intermediate relay server, by the insertion, in a DNS query received from the client terminal for the DNS resolution of the DNS query via the relevant parent server in the absence of a previous DNS resolution solution compatible with the domain name and stored at the extended intermediate relay server, of a distribution extension variable for this DNS resolution in order to generate an extended DNS query; and
(d) the relevant parent server, on confirming that the distribution extension variable is at the true value, searching for and/or sets up a distributed DNS resolution agent;
(e) the relevant parent server generating and transmitting to the extended intermediate relay server an extended DNS response containing at least the distributed DNS resolution agent, in order that the distributed DNS resolution agent is stored and executed at the extended intermediate relay server, to generate a DNS response containing at least the IP address associated with this domain name, the DNS response being transmitted from the extended intermediate relay server to the client terminal, thereby enabling the execution of the DNS resolution to be distributed at the extended intermediate relay server.

26. A method according to claim 25, wherein the step involving transmitting at least the distributed DNS resolution agent from the relevant parent server to the extended intermediate relay server comprises furthermore the transmission of a variable representing the time to live for the distributed DNS resolution agent.

27. A method according to claim 25, wherein, for an extended DNS query for which one of the two fields of the HINFO and TXT record type contains a distribution extension variable for this DNS resolution, the extended DNS response transmitted from the relevant parent server to the extended intermediate server includes at least:
the IP address associated with the domain name;
the distributed DNS resolution agent, inserted in the other of the two fields.

28. A computer program product including program code instructions recorded on a medium that can be read by a computer, in order to implement the steps of the distributed DNS resolution method for a DNS query according to claim 19 when the program is running on an extended intermediate relay server.

29. A computer program product including program code instructions recorded on a medium that can be read by a computer, in order to implement the steps of the distributed DNS resolution method for a DNS query according to claim 25 when the program is running on a relevant parent server.

30. An extended intermediate relay server for executing a distributed DNS resolution of a DNS query containing a domain name, this DNS query being transmitted between a client station and a relevant parent server, comprising:
means for checking for the presence of a previous DNS resolution solution compatible with the domain name and stored at the extended intermediate relay server;
means for storing and for inserting in the DNS query a distribution extension variable for this DNS resolution for generating an extended DNS query;
means for transmitting the extended DNS query to the relevant parent server;
means for storing and for executing a distributed DNS resolution agent transmitted by the relevant parent server to the extended intermediate relay server, in order to generate a DNS response containing at least the IP address associated with this domain name;
means for transmitting the DNS response to the client terminal.

31. An extended intermediate relay server according to claim 30, wherein the means for storing and for inserting in the DNS query a distribution extension variable for this DNS resolution include at least: a module for writing, in one of the two fields of the HINFO and TXT record type of this DNS query, a DNS resolution distribution extension variable, this variable being formed by a specific character string for which confirmation at the true value denotes a query declaring availability of the use of the distributed DNS resolution method at the extended intermediate relay server.

32. An extended intermediate relay server according to claim 30, further comprising at least one database of correspondence between a plurality of domain names and at least one distributed DNS resolution agent.

33. A relevant parent server for the execution of a distributed DNS resolution of a DNS query containing a domain name, this DNS query being transmitted from a client station to this relevant parent server, comprising:
means for receiving, from an extended intermediate relay server, an extended DNS query generated, at the extended intermediate relay server, by the insertion, in a DNS query received from the client terminal for the DNS resolution of the DNS query via the relevant parent server in the absence of a previous DNS resolution solution compatible with the domain name and stored at the extended intermediate relay server, of a distribution extension variable for this DNS resolution in order to generate an extended DNS query;
means for confirming that the distribution extension variable is at the true value;
means for searching for and/or setting up a distributed DNS resolution agent
means for generating and transmitting to the extended intermediate relay server an extended DNS response containing at least the distributed DNS resolution agent, in order that the distributed DNS resolution agent is stored and executed at the extended intermediate relay server, to generate a DNS response containing at least the IP address associated with this domain name, the DNS response being transmitted from the extended intermediate relay server to the client terminal, thereby enabling the execution of the DNS resolution to be distributed at the extended intermediate relay server.
